(19) United States
(12) Patent Application Publication
(10) Pub. No.: US 2007/0078744 A1
(43) Pub. Date: Apr. 5, 2007

(54) Methods and systems for providing ABS floating rate indices

(75) Inventors: Michael Andrew Koss, New York, NY (US); David K. Heike, New York, NY (US); Ross Bennett Shapiro, New York, NY (US); Akhil Mago, New York, NY (US); Brian Zola, New York, NY (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/541,147

(22) Filed: Sep. 28, 2006

Related U.S. Application Data
(60) Provisional application No. 60/721,786, filed on Sep. 28, 2005.

(51) Int. Cl. G06Q 40/00

(52) U.S. Cl. 705/36 R

(57) ABSTRACT

In at least one aspect, the invention comprises a method comprising creating, based on specified rules, an index of asset-backed floating rate securities categorized into a plurality of asset classes; and pricing the index according to a matrix pricing method. In at least one other aspect, the invention comprises an index of asset-backed floating rate securities categorized into a plurality of asset classes, wherein the index is created based on specified rules and priced according to a matrix pricing method. In at least one other aspect, the invention comprises a method comprising participating in a total return swap on an index of asset-backed floating rate securities categorized into a plurality of asset classes, wherein the index has been created based on specified rules and priced according to a matrix pricing method.

### CROSS REFERENCE TO RELATED APPLICATIONS

This application claims the benefit of U.S. Provisional Application No. 60/721,786, filed Sep. 28, 2005. The entire contents of that provisional application are incorporated herein by reference.

### INTRODUCTION

Lehman Brothers introduced the U.S. ABS Fixed-Rate Index in December 1992. The index initially covered three sectors: credit cards, auto loans, and home equity loans (HEL). In the late 1990s, rate-reduction bonds (December 1997) and manufactured housing (December 1998) became eligible for inclusion. In addition to the new collateral types, this index has gone through other changes during its 13-year history (see FIG. 1). In July 2000, the U.S. ABS index rules were revised to include a larger subset of issuers. Liquidity constraints were increased from $150 million minimum tranche size (no deal size requirement) to a $500 million minimum deal size and a $25 million current tranche amount outstanding. In December 2000, subordinates became eligible for index inclusion when the ERISA-eligibility guidelines were expanded to include investment-grade securities. Finally, in March 2003, the issuer inclusion list was amended by increasing the number of eligible issuers, resulting in an additional $28 billion in securities. The fixed-rate index now contains 644 bonds totaling $113 billion in market value, as of Mar. 31, 2005.

In the infancy of the ABS sector, bonds typically paid a fixed-rate coupon since most of the collateral being securitized was fixed rate as well. However, the introduction of the hybrid HEL, the growth in floating-rate credit card accounts, increased demand from investors for floating-rate product, and a steepening yield curve have made the issuance of floating-rate bonds more attractive for both issuers and investors. Prior to 2000, the percentage of floating-rate securities ranged between 40%-50%. Since 2000, this has increased dramatically, reaching a peak of approximately 75% in 2004. This has occurred alongside the rapid growth in overall ABS issuance volumes (see FIGS. 2 and 3).

The structural shift in the ABS market has necessitated a benchmark of floating-rate bond performance.

The total amount of U.S. ABS outstanding among the major sectors (HEL, autos, credit cards, and student loans) was roughly $1.14 trillion as of Feb. 28, 2005, split between floating ($850 billion) and fixed rate ($290 billion). This structural shift in the ABS market has necessitated a benchmark of floating-rate bond performance.

### SUMMARY

In at least one aspect, the invention comprises a method comprising the steps of: creating, based on specified rules, an index of asset-backed floating rate securities categorized into a plurality of asset classes; and pricing the index according to a matrix pricing method.

In various embodiments: (1) the matrix pricing method comprises asset-class-dependent steps; (2) the asset classes comprise two or more of: home equity loans, automobile loans, credit card debt, and student loans; (3) the asset classes comprise a home equity loan asset class, and wherein the matrix pricing method comprises determining a credit spread and determining one or more prepayment assumptions for each of one or more securities in the home equity loan asset class; (4) for each of one or more of the securities, the step of determining a credit spread is based on a credit rating of the security and a type of the security; (5) for each of one or more of the securities, the step of determining one or more prepayment assumptions is based on a pricing speed of the security; (6) the prepayment assumption is determined as follows: (a) for month 1-3, the prepayment assumption is the pricing speed of the security; (b) for month 4-6, the prepayment assumption is: (1 month constant payment rate plus 3 month constant payment rate plus 35 times constant payment rate) divided by 3; and (c) for months 7 and greater, the prepayment assumption is: (3 month constant payment rate times 75%) plus (3 year home equity loan prepayment model constant payment rate times 25%); (7) the asset classes comprise a student loan asset class, and wherein the matrix pricing method comprises receiving, for each of one or more securities in the student loan asset class, an input regarding a spread based on at least one of: average life, rating, and collateral type; (8) the asset classes comprise an automobile loan asset class, and wherein the matrix pricing method comprises determining, for each of one or more securities in the automobile loan asset class, a credit spread and one or more pricing speed assumptions; (9) the one or more pricing speed assumptions comprise using original pricing speed of a deal for nine months, then three-month historic average ABS speed thereafter; (10) the method further comprises dividing the index into pre-defined partitions to accommodate various investor styles; (11) partitions are based on one or more of: sector, quality, and average life; (12) the method further comprises creating a composite index of one or more floating rate and one or more fixed rate indices, wherein the one or more floating rate indices comprise the index of asset-backed floating rate securities; and (13) the method further comprises creating a total return swap on the index of asset-backed floating rate securities.

In at least one other aspect, the invention comprises an index of asset-backed floating rate securities categorized into a plurality of asset classes, wherein the index is created based on specified rules and priced according to a matrix pricing method.

In various other embodiments: (1) the matrix pricing method comprises asset-class-dependent steps; and (2) the asset classes comprise two or more of: home equity loans, automobile loans, credit card debt, and student loans.

In at least one other aspect, the invention comprises a method comprising participating in a total return swap on an index of asset-backed floating rate securities categorized into a plurality of asset classes, wherein the index has been created based on specified rules and priced according to a matrix pricing method.

In at least one other aspect, the invention comprises a method comprising accessing, via a computer network, data regarding one or more of returns and statistics for an index of asset-backed floating rate securities categorized into a plurality of asset classes, wherein the index has been created based on specified rules; and priced according to a matrix pricing method.

In at least one embodiment, the method further comprises accessing an electronic database storing the data regarding one or more of returns and statistics for the index.

### BRIEF DESCRIPTION OF THE DRAWINGS

FIG. 1 illustrates evolution of the Lehman Brothers U.S. ABS Fixed-Rate Index.

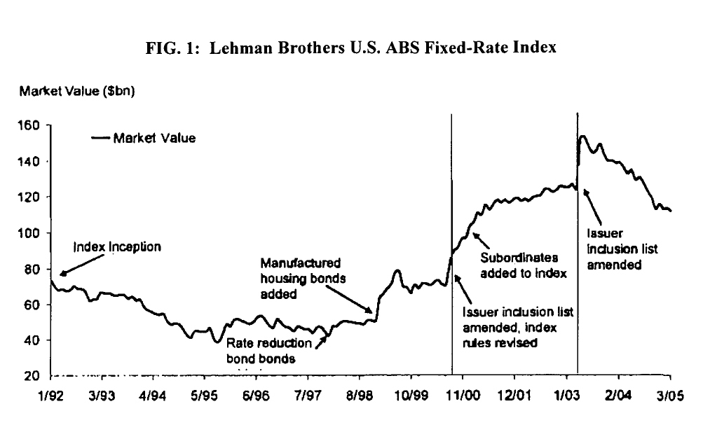

FIG. 2 shows evolution of yearly ABS issuance, fixed and floating, from 1993 through 2004.

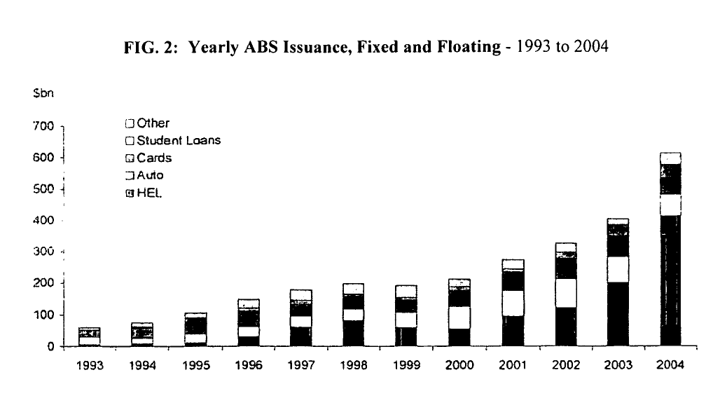

FIG. 3 depicts percentage of floating rate bonds, by collateral type, from 1993 through 2004.

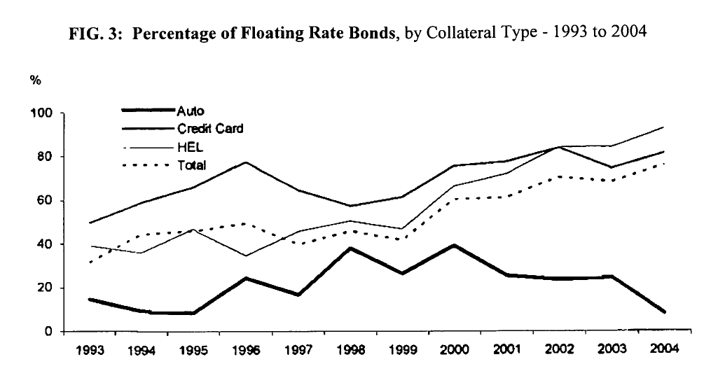

FIG. 4 illustrates composition of the floating rate market versus composition of the floating rate index, as of Mar. 31, 2005.

FIG. 5 depicts basic structure of a total return swap.

FIG. 6 depicts an excess and periodic returns screen.

FIG. 7 depicts a basic statistics screen.

### DETAILED DESCRIPTION OF VARIOUS EMBODIMENTS

A preferred embodiment of the present invention comprises the U.S. ABS Floating-Rate Index, a rules-based index. For a security to be index eligible, in at least one embodiment it must meet the following rules:
Collateral: Types are restricted to home equity, credit card, auto (retail and wholesale loans), and student loans.
Deal Size: The total at origination (including both fixed and floating-rate securities) must be greater than or equal to $500 million.
Tranche Size: The amount outstanding must be greater than or equal to $25 million.
Weighted Average Life: The WAL of the tranche must be greater than or equal to 1.0 year.
ERISA-eligible: Securities must be ERISA-eligible (no 144A or private securities).
Currency: U.S. dollar-denominated.
Coupon: Floating-rate.

Rating: The credit card, auto loan, and student loan sub-indices must contain investment-grade securities (BBB-/Baa3 and higher). The HEL sub-index may only contain Aa3 or higher securities, as a standardized process for pricing below Aa3-rated securities could lead to large discrepancies between the index price and the market price, due to varying prepayment rate, trigger, and loss assumptions. These differences lead to less variation in price at the Aa and Aaa level. See Table 1.

TABLE 1

| Index | Lowest Accepted Rating |
|---|---|
| Home Equity Loans | Aa3/AA- |
| Credit Cards | Baa3/BBB- |
| Auto Loans | Baa3/BBB- |
| Student Loans | Baa3/BBB- |

In at least one embodiment, the middle rating of Moody's, S&P, and Fitch is used to determine index classification. In cases where a security has only 2 ratings, the most conservative rating is applied. In various embodiments, high-LTV, interest-only (IO) securities, and net interest margin (NIM) loans are excluded; and HEL second-lien-only transactions are excluded.

Only the top issuers preferably are included to ensure pricing quality, liquidity, and transparency (see Table 2). These serve as the foundation of the index. If issuers currently excluded from the list become larger participants in the floating-rate market at a later date, they may subsequently be included. Any changes to the issuer inclusion list will be disseminated via public press release at least three months in advance of implementing the changes.

Those skilled in the art will recognize that issuer inclusion rules may vary among different embodiments of the present invention. Some other embodiments are discussed below.

TABLE 2
Issuer Inclusion List

| | | Credit | Student |
|---|---|---|---|
| HEL | Autos | Cards | Loans |
| Ameriquest/Argent | AmeriCredit | Amex | Sallie Mae |
| Chase | Capital One | Bank One | |
| Countrywide | Chase | Capital One | |
| CSFB | Daimler Chrysler | Chase | |
| Lehman Brothers | Ford | Citibank | |
| Long Beach | GMAC | Discover | |
| Morgan Stanley | Honda | MBNA | |
| Option One | Household | | |
| Residential Funding Corp. | Nissan | | |
| | Toyota | | |
| | WFS | | |

Issuer Inclusion (Second Embodiment)

The ABS Floating-Rate Index preferably closely mimics the scope, size, sub-sector proportions, and rating distribution of the market.

Scope and size: The floating-rate index preferably contains 22 different issuing companies, with the top 10 accounting for 81% of the index (see Table 4).

TABLE 4
Issuer Concentration*

| Issuer | Total ($bn) | % of Index |
|---|---|---|
| Sallie Mae | 42.3 | 16.7 |
| Ameriquest | 28.8 | 11.4 |
| Countrywide | 19.7 | 7.8 |
| MBNA | 19.1 | 7.6 |
| Lehman | 19.0 | 7.5 |
| Bank One | 17.8 | 7.0 |
| Chase | 16.3 | 6.4 |
| Citibank | 15.9 | 6.3 |
| GMAC | 13.5 | 5.4 |
| Amex | 12.2 | 4.8 |
| Capital One | 11.2 | 4.4 |
| Morgan Stanley | 9.2 | 3.7 |
| CSFB | 6.0 | 2.4 |
| Ford | 5.1 | 2.0 |
| Long Beach | 4.4 | 1.7 |
| Option One | 4.4 | 1.7 |
| Argent | 4.2 | 1.7 |
| Daimler Chrysler | 2.0 | 0.8 |
| Nissan | 1.3 | 0.5 |
| Americredit | 0.4 | 0.2 |
| Total | 253 | 100.0 |

*as of Mar. 31, 2005.

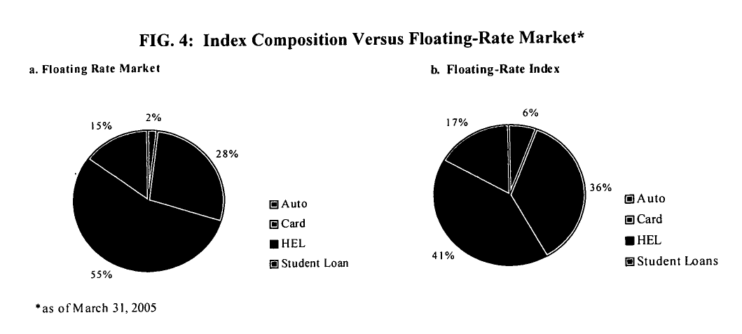

Subsector proportions: The overall floating-rate market (excluding non-index sectors) is 55% HEL, 28% credit cards, 15% student loans, and 2% auto loans. The current breakdown of the floating-rate index is similar: 41% HEL, 36% credit cards, 17% student loans, and 6% auto loans (see FIG. 4).

Rating distribution: The Aaa-rated portion of the floating-rate index is about 86% (see Table 5). The Aaa-rated portion of the HEL, credit card, student loan, and auto loan subindices is about 84%, 83%, 93%, and 97% respectively. This is consistent with typical deals in the various sectors. For most HEL deals, the AAA component is normally about 85%, 80%-84% for credit cards, 95-97% for auto loans, and 95%-98% for student loans.

TABLE 5
Market Value of Index by Rating and Average Life*

| Sector | MV | AAA Rated (%) | Non-AAA Rated (%) | 1-3 Yr | 3-5 Yr | 5-7 Yr | 7-10 Yr | 10+ Yr |
|---|---|---|---|---|---|---|---|---|
| Total | 253 | 85% | 14% | 64% | 22% | 8% | 5% | 1% |
| Auto | 14 | 97 | 3 | 96 | 4 | 0 | 0 | 0 |
| Credit Card | 90 | 83 | 17 | 46 | 33 | 11 | 9 | 1 |
| HEL | 106 | 84 | 16 | 82 | 14 | 4 | 0 | 0 |
| Student Loan | 42 | 93 | 7 | 44 | 24 | 13 | 14 | 5 |

*as of Mar. 31, 2005

U.S. ABS Composite Index: The performance of the entire U.S. ABS market may now be benchmarked through the combined floating- and fixed-rate indices. The floating-rate index will be about 70% of the total index, comparable to the overall market.

Issuer Inclusion Rules—Third Embodiment

The top 10 issuers for each index sector (e.g., HEL, credit card, student loan, auto loan) are included in the index. The ranking is determined using each issuer's total 3-year public issuance volumes (only eligible shelves will be included in the calculation). A $5 billion minimum 3-year total issuance requirement will be applied. See Table 6.

For HELs and student loans, issuance numbers include only floating-rate securities.

For credit cards and auto loans, issuance numbers include both floating- and fixed-rate securities.

Intex data will be used for HELs; Thompson Financial data will be used for credit cards, autos, and student loans (term-ABS only).

USD securities backed by non-U.S. collateral (e.g., Barclays credit cards) are excluded.

Cash flows must be made available through Intex or by issuer on a timely and regular basis.

Adding and Dropping an Issuer

In order to have a smooth transition year-to-year, as an issuer becomes eligible for the index, only its newly priced transactions will be included. Deals already in the market will not be added to the index. Similarly, issuers that are no longer included in the index will no longer have new-issue deals added to the index. However, the deals already in the index will not be taken out. These rules should alleviate any forced buying or selling of secondary issues. In addition, for total-return swap investors, the addition and deletion of issuers will have little immediate effect on the composition of the subindices and should not affect existing TRS trades.

TABLE 6
Issuer List

| | | | Student |
|---|---|---|---|
| HEL | Credit Cards | Autos | Loans |
| Ameriquest | Amex | GMAC | Nelnet |
| Bear Sterns | Capital One | AmeriCredit | Sallie Mae |
| Countrywide | Chase (inc. Bank One) | Capital One | SLC (Citi) |
| CSFB | Citibank | Chase | |
| First Franklin | Discover | DaimlerChrysler | |
| Lehman Brothers | MBNA | Ford | |
| Long Beach | Providian | GMAC | |
| Morgan Stanley | Nissan | Honda | |
| New Century | USAA | | |
| Residential | WFS | | |
| Funding Corp | | | |

Pricing the Index

The index preferably is priced daily using a matrix pricing method. Every Friday and at month-end, spreads are updated by traders and will account for issuer tiering, rating (including notching), and average life (see Table 7). Cash flows are generated using standardized methods that attempt to mimic those widely accepted by the market. ¹
¹ The cash flows for individual securities may be generated differently across sectors. Preferably a standardized method is used for each sector, which may incorporate the deal pricing speed, prepayment model, recent average CPR, and/or some combination of the above.

TABLE 7
Summary of Pricing Components

| Index | Pricing Speed | Matrix Inputs |
|---|---|---|
| Home Equity | New Issue, recent | WAL, price, |
| Loan Index | averages, LB | issuer tiering |
| | Prepayment Model | |
| Auto Index | New Issue | WAL, price, |
| | | issuer tiering |
| Credit Card Index | — | WAL, price, |
| | | issuer tiering |
| Student Loan Index | Trader inputs | WAL, loan type |

The preferred pricing methodology is different across the 4 asset classes: HEL, autos, credit cards, and student loans. All securities, however, preferably are matrix priced automatically each night.²
² Those skilled in the art will recognize that the described pricing rules may vary in detail and still be within the spirit and scope of the present invention. Additional embodiments and variations are described below.

Pricing Home Equity Loans:

To price an individual security in the index, we must arrive at a credit spread and prepayment assumption.

1) The credit spread is first determined by using the rating of the security and type of security. Spreads are input into a spreadsheet by ABS traders for “Tier 2” issuers, by average life of the security, and by security type (e.g., AAA sequential vs. passthrough). The traders then assume a spread add-on by average life for tier 3+ issuers and subtract a spread for tier 1 issuers. Traders have tiered all issuers included in the index and may vary the assigned tiering at any point based on a shift in the market for that issuer's securities.

2) Determine the prepayment assumption.

For month 1-3, assume the pricing speed of the security.

For month 4-6, the prepayment assumption=(1 mo CPR³ +3 mo CPR +35 CPR)/3.
³ CPR (constant payment rate) measures prepayments as a percentage of the current outstanding loan balance, expressed as a compound annual rate. 10% CPR assumes that 10% of the pool's current balance prepays annually.

For month 7+, the prepayment assumption=(3 mo CPR*75%)+(3 yr Lehman HEL Model Prepayment Projection (CPR)*25%). The Lehman HEL Model is known to those skilled in the art. Other HEL prepayment models may be substituted for the Lehman HEL prepayment model.

This approach after 6 months is unique in that the prepayment assumption relies heavily on the historical data (market convention), but also takes into account some projected performance. Relying solely on historical prepayment speeds in a very high prepayment environment would grossly overstate the future prepayments and significantly reduce the average life of the security. The model provides some sanity check on historical prepays.

3) Call/no call—If the price of the security is $99.5 or greater, the security is re-priced “to-call”. If the price is less than $99.5, it is priced “to maturity.”

4) Premium spread add-on—If the market builds in additional spread pick-up for premium dollar prices, the trader has the ability to incorporate this into the pricing of the security.

More details on a preferred HEL prepayment model are provided in the Appendix.

Student Loans

In at least one embodiment, the only student loan issuer in the index is Sallie Mae. However, this may change in other embodiments. Cash flows generated by Sallie Mae are received on a quarterly basis. The cash flows are for each security under a variety of prepayment assumptions. Therefore, to price the security, the traders input a spread based on the average life, rating, and collateral type (FFELP,⁴ private) to determine the spread of the individual security.
⁴ Prepayment assumptions are made dependent on the collateral type, vintage, and average life.

Credit Cards

Credit card prices preferably are determined by coming up with the credit spread for the individual security and pricing the security through Bloomberg models. The asset class does not require a prepayment assumption since the bonds are bullet maturities. The spread is determined similar to other indices: by rating, average life, issuer tiering, and price (determined “to-call” or “to maturity” calculation).

Auto Loans

Auto loan prices are determined by coming up with the credit spread and pricing the security to the pricing speed assumption. The spread is determined similar to other indices: by rating, average life, issuer tiering, and price (determined “to-call” or “to maturity” calculation).

Returns on auto ABS are dependent on the prepayment assumptions used to price the bonds. One embodiment uses the initial pricing speed to determine the average life of an auto ABS bond and determine the greeks (similar to the Fixed Rate Index). Another embodiment uses a deal's original pricing speed only for the first nine months. After that, the prepayment speed switches to the three-month historic average ABS speed using Intex reported numbers. This will determine the bond's WAL, and a price will be calculated accordingly. Once the price is calculated, the bonds are re-run at that price using the Lehman Brothers Auto ABS Prepayment model to calculate the bond's greeks. This affects only the retail auto portion of the sector, not the pricing of dealer floorplan transactions. The Lehman Brothers Auto ABS Prepayment model is periodically updated, and is available at live.lehman.com. Other auto prepayment models also may used in this context.

Certain features preferably included in such models include the following: (a) periodic re-calibration with annual performance data; (b) reflect Intex's prepayment methodology in the voluntary prepayment model; and (c) incorporate the effect of loan compression into prepayment projections. Other preferred features include measuring prepayments using multiple representative loans, correcting for prepayment inflation caused by higher than expected prepayments, and adjusting to account for changes in adverse selection implications of long term (e.g., 72-month) loans.

Applications

The invention described herein, in general and in each of the described embodiments, provides useful, concrete, and tangible results. The index, in itself, is a useful, concrete, and tangible result. The index provides investors with the ability to benchmark their own performance, look at trends in the market, and buy or sell the index through a total-return swap.

Performance Benchmark

A concrete and tangible use for the index is as a benchmark for floating-rate portfolio performance. Total and excess returns versus treasuries and swaps preferably are calculated on a daily basis. The index will contain pre-defined partitions (e.g., sector, quality, average life) to accommodate different investor styles. Additionally, ABS investors can now benchmark against the U.S. ABS Composite Index, which is a market-value weighted index comprising both the fixed- (currently about 30%) and floating-rate (about 70%) indices.

ABS Index Total-Return Swaps

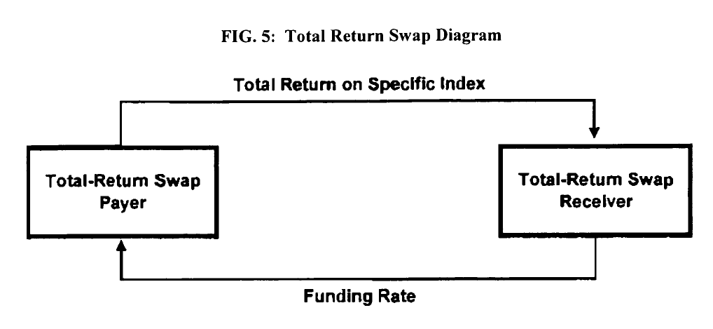

Another concrete and tangible application is total-return swaps (TRS) on the ABS floating-rate index. In a TRS, the receiver would get the total return of the specific index at each month's end and pay a funding rate to the TRS payer (see FIG. 5). Investors have been active in TRS on Lehman Brothers' U.S. CMBS Index. A similar interest is expected for the U.S. ABS Floating-Rate Index.

Reasons to receive on a TRS:
Investment managers might wish to gain exposure to the ABS market (or sub-sectors) without having to make individual security purchases. A TRS on a diversified index reduces the amount of due diligence, credit analysis, and time needed to transact in the market.

Reasons to pay on a TRS:
Investors with a portfolio of ABS might wish to hedge against negative returns in the sector.
Speculative investors might wish to place an outright short on the market.

Accessing the Index

In one embodiment, there may be three sources to monitor index performance:

Bloomberg, POINT, and LehmanLive's index site.

Bloomberg: Type LEHM <GO> to take you to the index selection screen for Lehman's Global Family of Indices. Select “Other” from the U.S. & Canada column. Then select U.S. ABS Floating-Rate Index. This will provide the monthly and daily index returns and statistics.

LehmanLive: Investors may also retrieve index returns and statistics from the index site on LehmanLive. This site allows entitled users to access and download historical index returns and statistics of the entire Global Family of Fixed Income Indices back to each index's inception date. Go to the Fixed Income page and click on “Fixed Income Indices.” The U.S. ABS Floating-Rate Index link will be listed as a separate page under “OtherAmericas.”

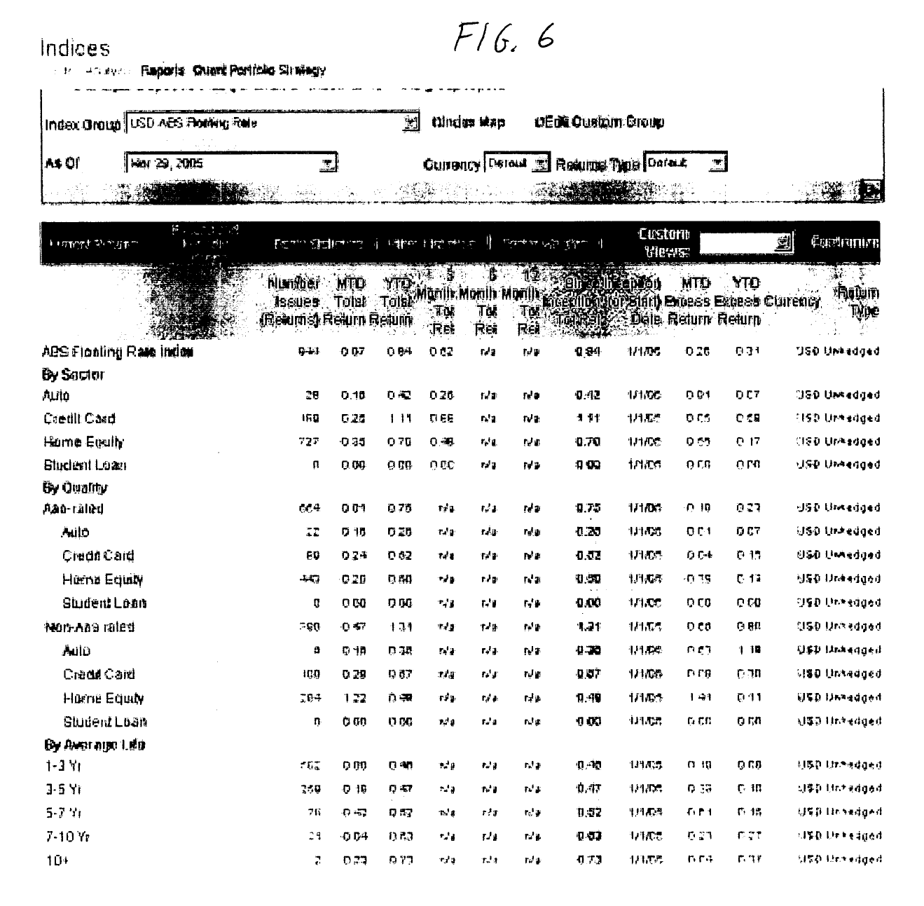

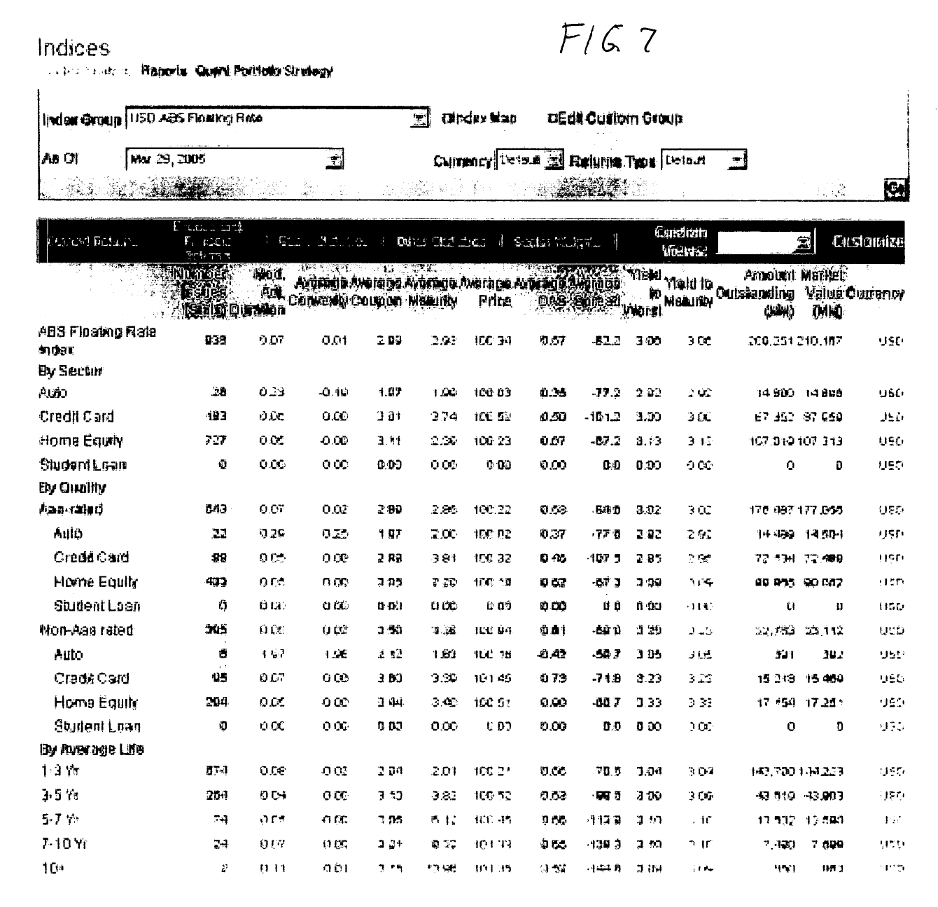

POINT: For investors with access to POINT, Lehman's risk management and portfolio analysis tool, the index returns and statistics will be retrievable by loading the U.S. ABS Floating Rate Index. FIGS. 6 and 7 depict some example reports of the content that can be found on Lehman Live. FIG. 6 depicts an excess and periodic returns screen, and FIG. 7 depicts a basic statistics screen.

Embodiments of the present invention comprise computer components and computer-implemented steps that will be apparent to those skilled in the art. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

For example, all calculations preferably are performed by one or more computers. Moreover, all notifications and other communications, as well as all data transfers, to the extent allowed by law, preferably are transmitted electronically over a computer network. Further, all data preferably is stored in one or more electronic databases.

In general, although particular embodiments of the invention have been described in detail for the purpose of illustration, it is to be understood that such detail is solely for that purpose and that variations can be made thereof by those skilled in the art without departing from the scope of the invention, which should be determined exclusively from the plain wording of the appended claims. Any details in the specification that are not included in the claims themselves should not be construed as limiting the scope of the invention.

### APPENDIX

### Preferred HEL Model

Lehman Brothers has a longstanding commitment to the Home Equity Loan (HEL) sector. As early as 1996, when HEL issuance was less than $15 billion, Lehman Brothers (“LB”) released its first HEL-specific prepayment model; in 2002, LB recalibrated and updated the model to better account for prepayment penalties. As the market matured, so have client needs; while fixed rate mortgages (FRMs) comprised the majority of the loans securitized in 1996, they were only about 30% of the loans in 2004 transactions and are in most cases mixed with floating rate loans backing floating rate deals. For this reason, adjustable and hybrid rate mortgages are incorporated into the latest version of the model.

The role of option adjusted spread (“OAS”) analysis in the sector has also changed. Most of the HEL bonds are floating rate, and the OAS of a par bond equals the promised spread, so long as there are enough funds in the trust actually to pay the promised coupons. The classical OAS analysis helps distinguish those bonds that are more likely to be subject to the available funds cap (“AFC”), but misses a lot of the determinants of the “true” AFC. The true cap on bond interest payments is significantly affected by both triggers (driven by delinquencies) and losses. Collateral losses, in turn, may or may not translate into bond losses depending on prepayments and interest rates. Credit and OAS analysis are, therefore, merging. The latest HEL model extends interest rate simulations to subprime rates and provides a forecast of both delinquencies and defaults in each rate scenario, extending the OAS analysis with many of the credit components it was missing. The model, however, does not forecast losses; precision requires knowledge of collateral characteristics (such as FICO and LTV) that are not available to the model.

The model projects prepayment, default, and delinquency vectors for each pool in the deal, along each rate scenario. It uses data typically available in cash flow models, such as product type, WAC, penalties, and caps. For this reason, it can run on any cash flow model and produce a reasonable projection for virtually any HEL deal. The model relies on spread at origination (“SATO”) as a proxy for credit quality. SATO is good at explaining rate sensitivity, delinquencies, and overall defaults, but more data would be necessary for a severity model.

In the following, we first explain our definition of default and our methodology to create HEL mortgage rates and SATOs. We then delve into how the new model projects prepayments and credit; for both, we look at the main drivers, both in terms of macro variables and loan characteristics.

Building Reference Rates and SATO

The first building block of the model is the reference mortgage rate. The model has two reference rates, a 2/28 hybrid and a 30 year fixed rate. Similar to most rate sheets, we assume 3/27 rates (with three years of penalty) are the same as 2/28 rates (with two years of penalty), and 5/25 hybrid rates are the same as 30 year fixed rates. These rates are used both to compute each pool's SATO and its refinancing incentive after origination. Both are very important for the model. SATO is the difference between the WAC on a pool and the “typical” WAC on other pools originated in the same month. Since, on average, worse borrowers will pay higher rates, we use SATO as our main measure of credit quality. The refinancing incentive is the expected financial gain that a borrower may have from refinancing and drives the model's prepayments.

The choice of reference rates is, therefore, crucial. Both reference rates in the model are subprime specific. Prime mortgage rates are problematic for two reasons. First, 2/28s, which are about half of subprime mortgages, are not common outside subprime. Second, the observed prime subprime rate differential is driven by a variety of factors, including originator margins and costs and investor appetites. These are not changes in the underlying risk of the loans; also, since most HEL borrowers do not cure all the way into prime, this spread change does translate into a change in refinancing incentive. Using prime mortgage rates as a reference would miss both marks. For example, tighter mortgage credit spreads should increase the refinancing incentive as existing subprime borrowers find attractive opportunities to refinance into new subprime loans, but should not be interpreted as a SATO drop and an increase in credit quality. Using the prime mortgage rates as a driver of subprime prepayments would miss this improved opportunity to refinance an existing loan. It would also assign a lower SATO to new loans, incorrectly signaling that new loans are of higher credit quality.

Our starting point is, thus, the monthly WAC by product (30 year, 2/28) of every A grade HEL loan in the LoanPerformance database. We “quality adjust” these WACs by making sure that the mix of FICO, LTV, documentation, and penalties is kept constant over time. This compensates for the changes in the average quality and penalties of subprime mortgages. The rate on fixed rate loans, for example, has gone down in past years both because rates are dropping and because subprime fixed rate production has been reaching toward Alt A. By quality adjusting the WACs, we make sure we eliminate the rate drop due to quality changes.

Since our reference rates are of constant quality, we can interpret each pool's SATO as a measure of relative quality across time. We cannot, however, use SATO to compare the quality of a hybrid and a fixed rate mortgage. The “constant” quality is not the same across products, and a given increase in risk likely translates in different amounts of additional SATO.

Defining Defaults

Before showing how the model projects defaults and voluntary prepayments, we need to define them. As investors know, the definition of “default” is not unique. While total prepayments and the amount of loss that are generated by a pool of collateral are typically quite clear, the portion of prepayments resulting from defaults is defined in different ways by different providers. In some cases, the defaults include only those loans that actually had a loss. Some people have advocated also including any REO liquidation, even if there were no loss. In our case, we did not always have loan level loss data for our estimation, so we had to define defaults in a different way: any termination on a loan that was at least 60 days delinquent (OTS style) on the month prior to the termination. This means, for example, that if a borrower is current as of the January payment, misses February and March, and prepays in April, this would not be considered a default, but it would be if the borrower also missed the April payment and the loan was terminated in May. This more enlarged definition of default may be seen as encompassing all “involuntary prepayments,” i.e., those situations when the borrower would not have wanted to prepay, but did so to exit a difficult economic situation (e.g., by selling the home), possibly without even causing any loss to the trust.

Ultimately, what matters for bondholders are losses, not defaults. Since our definition of CDR includes several zero severity terminations, the average severities need to be lower. For example, while the historical life severity for a large pool of 2000 vintage deals using the most stringent definition of CDR (loss terminations only) is about 39%, it becomes only 23% when using all involuntary prepayments.

Drivers of Voluntary Prepayments

The model thus breaks down total prepayments into voluntary and involuntary, using different drivers for each. Voluntary prepayments for subprime mortgages can be largely viewed as having four main components: turnover, curing, rate refinancing, and cash out. While we do not observe each component separately, the model has parts intended to capture each of those. We describe them here and provide more detail on some of the effects in later sections:
Rate Refinancing: These are prepayments that take place when market rates decline and the borrower is presented with a rate incentive to refinance. Loan and borrower characteristics play an important role in this process. Without doubt, better quality (low SATO) borrowers are more sensitive to rate changes. Penalties, on the other hand, reduce the rate incentive when they are in effect, but these same borrowers who postponed their prepayments will actually be extremely rate sensitive at the penalty expiration date, justifying much of the familiar surge in prepayments for 2/28s at their penalty expiration (and first reset). State composition of the pool and loan size also matter. Borrowers in some states are more prone to rate refinancing due to lower fixed costs; similarly, larger loans react more quickly to rate drops because they are less affected by fixed costs. Moreover, better quality, low SATO borrowers are more sensitive to rate changes. Finally, as the pool composition changes due to past rate refinancings, the burnout effect changes the rate sensitivity.
Cash out Refinancing: This includes all those prepayments whereby borrowers take out bigger loans than they previously had. In general, a cash out has two main drivers: home prices and interest rates. As home prices go up, the borrower can get a bigger loan without being placed into higher LTV buckets, thereby avoiding higher rates. As rates decline, more borrowers will actually be able to afford to pay interest on a larger loan. Therefore, cash outs in the model have both a base component driven by home prices alone and a sizeable additional component that kicks in when home prices go up and rates decline.
Curing: This includes those prepayments driven by drops in the borrower's rate, where the rate drop itself was created by an improvement in the borrower's credit or the loan's LTV. Curing is affected by several different factors. Seasoning and initial SATO are the main drivers, but certain macro variables affect the curing rate. First, as the economy strengthens, borrowers' credit improves and they are able to obtain a better rate on their mortgages. Home prices also affect curing. While most of this effect is confounded with cash outs, the model specifically recognizes that second liens are more sensitive to home price appreciation because it allows the borrower to refinance into a lower LTV mortgage. Curing is also affected by interest rates: if they go up enough, there is no curing that will ever justify a rational prepayment.
Turnover: This includes borrowers' prepaying as a result of selling their homes (not including defaults). While turnover is affected by a lot of the same macro factors that drive the other components (e.g., rates), it is largely captured by seasoning and seasonality. Turnover is also affected by penalties since borrowers who are less likely to move soon are also more likely to take penalty loans.

The Effect of Interest Rates

Rate refinancing is probably the most important component of a prepayment model because the relationship between prepayments and interest rates creates the negative convexity for which investors need to be compensated.

The rate incentive in the model is equal to the negative of the change in subprime rates since origination. Since the model is estimated largely on post-1997 observations, it has only one substantial backup, in 2000, to estimate prepayments in a rising rate environment. We have been extremely careful to fit those prepayments. Moreover, we use prepayments on penalty loans to infer general out of the money speeds. Penalty loans are slower for two main reasons; first, borrowers who do not intend to prepay immediately self select themselves into those loans; second, borrowers have a financial disincentive to prepay. The model accounts for the “self selection” effect and also translates the upfront financial disincentive into a reduction in rate incentive, which is comparable to a rate backup.

While a generic prepayment curve is useful for a basic understanding of the effect of a rate backup, the model needs to be able to discern the callability of different pools. The model achieves this through the use of SATO. The better loans are originated at lower rates (lower SATOs) and are more callable.

The Effect of Home Prices

Home price appreciation (HPA)—at close to 10% a year in the areas where HELs are originated—has had a pronounced effect on prepayments over the past few years. Areas of higher home price appreciation have been prepaying substantially faster than the rest of the country, even after adjusting for loan characteristics. When developing the model, we have extended our understanding of the effect of home prices on prepayments. We find that observed effect of positive HPA is amplified in declining rate environments, when enhanced affordability increases subprime borrower's appetite for cash out and trade up opportunities. Oppositely, the effect of home prices on out of the money prepayments is considerably reduced. The effect of home prices on out of the money prepayments is considerably reduced both in the actual and estimated prepayments. Therefore, the model projects that if subprime rates back up, the effect of different home price appreciation scenarios on prepayments will be relatively small. The model uses the top 5 state distribution to compute historical accumulated appreciation and uses a default 5% future yearly appreciation.

Loan Size

Many loan characteristics are unavailable at the pool level. Loan size, however, is often available in the INTEX database and has a strong effect on both base prepayments and the interest rate sensitivity of a pool. Pools of different loan sizes have experienced very different “base” prepayments, which are the prepayments that would take place if rates were unchanged; we compute them by subtracting the estimated effect of rates from the actual overall prepayments. Loan size affects base prepayments since a sizeable chunk of those prepayments is actually driven by curing, which manifests itself as a lower rate for the borrower; this lower rate can be more easily seized when fixed costs are spread over a larger loan.

Hybrid Prepayment Spike

Most HEL origination is currently hybrid mortgages, most of which are 2/28s. These mortgages typically have two features that are important in this context. First, they have prepayment penalties of duration equal to the initial fixed rate. Second, they have a floor in their floating rate period equal to the initial fixed rate.

Hybrid mortgages exhibit a sizeable spike in prepayments right after the date when the penalty and the fixed rate end. This spike largely disappears for no penalty loans and is, thus, mostly a penalty expiration effect.

How rates change at the reset date affects the prepayment spike. In most of the recent HEL history, hybrid mortgages were floored out and did not experience any rate change at the reset. Loans originated in 2004, though, may have an experience which resembles more that of the 1998 loans. Two features make the two vintages comparable. The first is teaser rates. This is the characteristic of giving borrowers an initial fixed rate lower than their “fully indexed rate,” or the margin plus the 6 month LIBOR as of the origination date. Teasers can be seen as a way “automatically” to increase payment if the borrower does not prepay, which is typically because the credit has not improved as expected. Teaser rates largely disappeared in the middle of 2001 as the yield curve started to steepen, but have re surfaced with the 2004 vintage, as 2/28 rates declined, LIBOR increased, and margins were largely unchanged. Teaser rates ensure that there is an expected rate shock. The second similarity with the 1998 vintage is that given Fed policy, short rates may actually be increasing over the first few years of the life of the mortgages.

These two effects create both a lack of rate incentive during the fixed rate period (as rates back up) and a sizeable rate spike at the first reset. This happened last to the 1998 vintage. The 1998 loans had slow initial prepayments during the backup, but eventually had a larger spike at the two year mark. We expect (and so does the model) a similar behavior for the 2004 vintage. Even with a relatively different economic environment, the post reset prepayments have been very similar between 1998 and 2000 vintages. We expect the 2004 post reset prepayments to similarly stabilize at around 40% CPR.

Drivers of Credit

The model projects defaults and delinquencies over time for each pool and rate scenario. The user is able to set loss severity in such a way as to target a specific amount of losses. Both delinquencies and defaults are driven by similar factors, as discussed below.

Spread at Origination (SATO)

SATO has a large effect on credit performance. While the rate (and thus SATO) on a given loan is partly driven by non credit related factors, including points paid and borrower negotiations, the main driver of the average SATO of a pool of several hundred loans is the credit quality of the loans. Higher SATO pools have experienced significantly higher defaults and delinquencies.

Prepayment Effect

It typically takes about 18 months to liquidate a loan. Faster prepayments during the liquidation period result in a lower pool balance at the liquidation date. The same amount of liquidated loans will, thus, produce a higher CDR if CPRs are faster. The issue becomes particularly important when using a CPR vector with sizeable variations, such as what the model has for penalty loans, especially hybrids, or when prepayments change by rate scenario. This is a well known issue for investors, typically faced in one of two ways.

An extreme approach is to specify the default curve as a percentage of the original balance and let the CDR be determined by the balance outstanding. This is the approach typically used by the rating agencies. It completely de links prepayments and defaults, creating an extreme view that a loan expected to default in a few years will not prepay today no matter how much rates decline or home prices go up. It can also produce extremely high or low default rates in the tail if prepayments are very fast or very slow. While this is a good first approximation, it is either not satisfactory or extremely cumbersome when dealing with pools that have very different speeds or when these speeds change across interest rate scenarios.

Another approach is to introduce a delay in the application of the CDR. This means expressing the defaults as a percentage of the balance outstanding a given number of months before the liquidation occurs so that the actual CDR as a percentage of the current balance will be higher when prepayments are higher during those months. The CDR curves of products with different prepayment patterns are far more similar when a delay is used. While we find this to be a more reasonable approach, it also has drawbacks. Mostly, it is hard, if not impossible, to use on seasoned deals; with an 18 months delay, there are no defaults at all for the first 18 months. While this is almost reasonable for a new deal, it totally misses the mark on even moderately seasoned deals.

The model employs a variation on this second approach. It utilizes a mix of different delays, from 6 to 36 months, to account for the fact that some loans will be liquidated faster than others; it also always runs all pools from the cutoff date of the deal, thus treating seasoned deals consistently with their new issue projections. The model cumulative default curves will thus be largely unaffected by prepayments for their first one or two years, but will eventually be higher for slower prepayment scenarios. We also tweak the calculation for deals with second liens, reducing the CRR effect proportionally to the percentage of seconds, since second lien liquidations are very fast.

Other Drivers

The model also makes use of other variables to project credit performance. Employment growth and home price appreciation have a sizeable effect. Similar to what is done for prepayments, the model uses the top 5 state distribution to compute the historical values, while expected future changes can be modified in the preferences part of our calculator, as shown in the appendix. The model uses employment growth, instead of unemployment rate. While this is less commonly looked at, it provides a better picture since it is not influenced by people leaving or entering the labor force as wages change. The typical value for employment growth is the rate of population growth, or about 1.2% per annum, our default value.

Liquidation timelines, which we take from the state distribution of the pool, also affect credit in various ways. Longer timelines increase delinquencies and back end defaults, but decrease initial defaults. Finally, the model uses the WALA of each pool at cutoff to modify the initial defaults and delinquencies. Pools that are more seasoned when they enter the deal by even a few months have a worse credit performance at low deal age.

Error Correction

The model has a self adjustment for credit. When delinquencies are different from the original expectation, both projected delinquencies and defaults are adjusted accordingly. Projected delinquencies are essentially shifted up or down by the most recent projection error. We find this to give a great improvement in the precision of our projection for even moderately seasoned pools. Defaults are also updated, but this adjustment is more limited both in size and in how much it improves the fit. We find that many deals have in the past reported delinquencies that were different from the model expectation, but defaults were not.

We claim:

1. A method comprising the steps of:
creating, based on specified rules, an index of asset-backed floating rate securities categorized into a plurality of asset classes; and
pricing said index according to a matrix pricing method.

2. A method as in claim 1, wherein said matrix pricing method comprises asset-class-dependent steps.

3. A method as in claim 1, wherein said asset classes comprise two or more of: home equity loans, automobile loans, credit card debt, and student loans.

4. A method as in claim 1, wherein said asset classes comprise a home equity loan asset class, and wherein said matrix pricing method comprises determining a credit spread and determining one or more prepayment assumptions for each of one or more securities in said home equity loan asset class.

5. A method as in claim 4 wherein, for each of one or more of said securities, said step of determining a credit spread is based on a credit rating of said security and a type of said security.

6. A method as in claim 4 wherein, for each of one or more of said securities, said step of determining one or more prepayment assumptions is based on a pricing speed of said security.

7. A method as in claim 6, wherein said prepayment assumption is determined as follows:
(a) for month 1-3, said prepayment assumption is the pricing speed of the security;
(b) for month 4-6, said prepayment assumption is: (1 month constant payment rate plus 3 month constant payment rate plus 35 times constant payment rate) divided by 3; and
(c) for months 7 and greater, said prepayment assumption is: (3 month constant payment rate times 75%) plus (3 year home equity loan prepayment model constant payment rate times 25%).

8. A method as in claim 1, wherein said asset classes comprise a student loan asset class, and wherein said matrix pricing method comprises receiving, for each of one or more securities in said student loan asset class, an input regarding a spread based on at least one of: average life, rating, and collateral type.

9. A method as in claim 1, wherein said asset classes comprise an automobile loan asset class, and wherein said matrix pricing method comprises determining, for each of one or more securities in said automobile loan asset class, a credit spread and one or more pricing speed assumptions.

10. A method as in claim 9, wherein said one or more pricing speed assumptions comprise using original pricing speed of a deal for nine months, then three-month historic average ABS speed thereafter.

11. A method as in claim 1, further comprising dividing said index into pre-defined partitions to accommodate various investor styles.

12. A method as in claim 11, wherein partitions are based on one or more of: sector, quality, and average life.

13. A method as in claim 1, further comprising creating a composite index of one or more floating rate and one or more fixed rate indices, wherein said one or more floating rate indices comprise said index of asset-backed floating rate securities.

14. A method as in claim 1, further comprising creating a total return swap on said index of asset-backed floating rate securities.

15. An index of asset-backed floating rate securities categorized into a plurality of asset classes, wherein said index is
created based on specified rules; and
priced according to a matrix pricing method.

16. An index as in claim 15, wherein said matrix pricing method comprises asset-class-dependent steps.

17. An index as in claim 15, wherein said asset classes comprise two or more of: home equity loans, automobile loans, credit card debt, and student loans.

18. A method comprising:
participating in a total return swap on an index of asset-backed floating rate securities categorized into a plurality of asset classes,
wherein said index has been created based on specified rules and priced according to a matrix pricing method.

19. A method comprising:
accessing, via a computer network, data regarding one or more of returns and statistics for an index of asset-backed floating rate securities categorized into a plurality of asset classes,
wherein said index has been created based on specified rules; and priced according to a matrix pricing method.

20. A method as in claim 19, further comprising accessing an electronic database storing said data regarding one or more of returns and statistics for said index.
